(19) United States
(12) Patent Application Publication
(10) Pub. No.: US 2024/0127763 A1
(43) Pub. Date: Apr. 18, 2024

(54) DISPLAY DEVICE

(71) Applicant: NIPPON SEIKI CO., LTD., Niigata (JP)

(72) Inventor: Hideaki TSURUMI, Niigata (JP)

(21) Appl. No.: 18/548,287

(22) PCT Filed: Apr. 26, 2022
(86) PCT No.: PCT/JP2022/018906

§ 371 Date: Aug. 29, 2023

(30) Foreign Application Priority Data
Apr. 27, 2021 (JP) 2021-075363

(51) Int. Cl. G09G 3/34; G09G 3/00; G09G 3/36

(52) U.S. Cl. CPC G09G 3/3413; G09G 3/002; G09G 3/36; G09G 2320/0242

(57) ABSTRACT

A display device includes laser light sources that emit light beams; synthesis units synthesizing the light beams; a collimator lens collimating the synthesized light beams: a liquid crystal panel forming an image for display; and a control unit controlling the laser light sources. The liquid crystal panel is illuminated using the collimated light beams. The display device further includes an optical detection unit detecting the intensity of the light beams from the synthesis units. The control unit performs periodic switching between an all-color lighting mode, in which all the laser light sources are turned on, and a single-color lighting mode, in which one of the laser light sources is turned on. The control unit causes the optical detection unit to detect the optical intensity in the single-color lighting mode, and adjusts the gain of each of the laser light sources in the all-color lighting mode based on the detected value.

### TECHNICAL FIELD

The present disclosure relates to a display device.

### BACKGROUND ART

Patent Document 1 discloses a head-up display in which monochromatic light emitted from a green laser diode is collimated by a YAG laser rod to illuminate a liquid crystal panel.

### PRIOR ART DOCUMENT

### Patent Document

Patent Document 1: Japanese Unexamined Patent Application Publication No. 2-103586

### SUMMARY OF THE INVENTION

### Problems to be Solved by the Invention

It is also proposed to synthesize a plurality of laser beams of different colors to produce white light, and then collimate the white light to illuminate a liquid crystal panel. However, it is difficult to maintain a good balance of white color because the light intensity of the laser beam emitted by the laser light source fluctuates with temperature.

Therefore, it is an object of the present disclosure to provide a display device that illuminates a liquid crystal panel by synthesizing a plurality of laser beams of different colors and that is capable of adjusting the balance of the synthesized beam with high accuracy.

### Solution to Problem

In one aspect, provided is a display device (1) including a plurality of laser light sources (21-23) that emit a plurality of laser beams (B, R, G) of different colors, synthesis units (24-26) that synthesize the plurality of laser beams and emit a synthesized beam, a collimator unit (41) that collimates the synthesized beam and emits a collimated beam, a liquid crystal panel (6) that forms an image for display, and a control unit (7, 7A) that controls the plurality of laser light sources. The display device (1) illuminates the liquid crystal panel with the collimated beam, and further includes an optical detection unit (28) that detects light intensity of the laser beams that have passed through the synthesis units. The control unit performs periodic switching between an all lighting mode in which all of the plurality of laser light sources are turned on and a single-color lighting mode in which any one of the plurality of laser light sources is turned on, detects the light intensity in the single-color lighting mode by the optical detection unit, and adjusts a gain of each laser light source in the all lighting mode on basis of a detection value detected by the optical detection unit.

### Effect of the Invention

According to the present disclosure, it is possible to illuminate a liquid crystal panel by synthesizing a plurality of laser beams of different colors and adjust the balance of synthesized beam with high accuracy.

### BRIEF DESCRIPTION OF THE DRAWINGS

FIG. 1 is a diagram schematically illustrating a state where a head-up display is mounted on a vehicle in a side view of the vehicle.

FIG. 2 is a schematic diagram illustrating a configuration of a display device.

FIG. 3 is a block diagram illustrating configurations of a light source unit and a control unit according to a first embodiment.

FIG. 4 is a timing chart illustrating an operation timing of the display device according to the first embodiment.

FIG. 5 is a flowchart illustrating a control procedure of the display device according to the first embodiment.

FIG. 6 is a block diagram illustrating configurations of a light source unit and a control unit according to a second embodiment.

FIG. 7 is a timing chart illustrating an operation timing of a display device according to the second embodiment.

FIG. 8 is a flowchart illustrating a control procedure of the display device according to the second embodiment.

### MODE FOR CARRYING OUT THE INVENTION

Embodiments will be described in detail below with reference to the accompanying drawings.

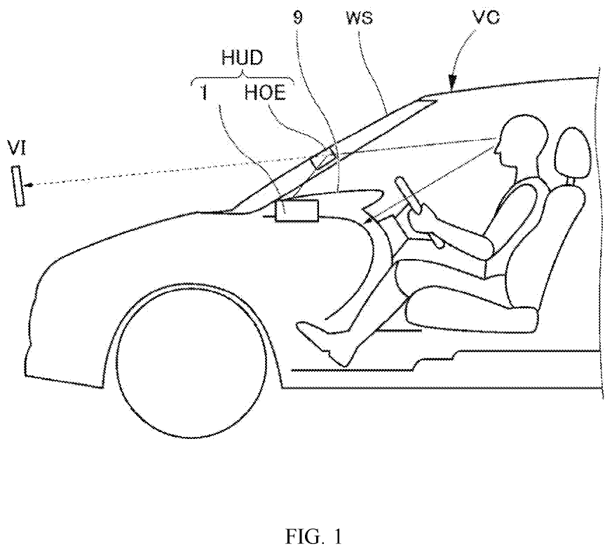

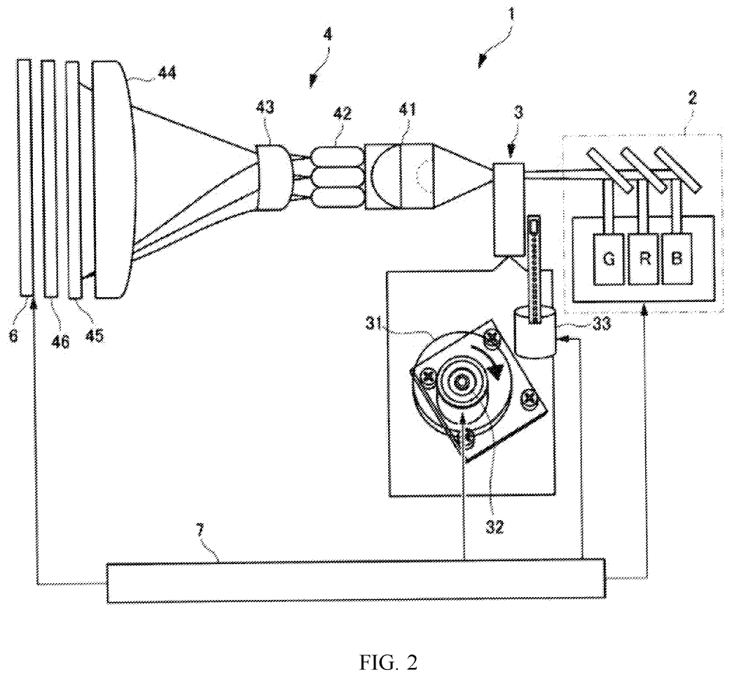

FIG. 1 is a schematic diagram illustrating a state where a head-up display HUD is mounted on a vehicle in a side view of the vehicle, and FIG. 2 is a schematic diagram illustrating a configuration of a display device 1.

With the head-up display HUD, as illustrated in FIG. 1, when a windshield WS is irradiated with the display light, a driver who drives a vehicle VC can see a display image (virtual image display) VI obtained by the irradiation in front of the windshield WS. This allows the driver to visually recognize the display image VI superimposed on the forward scenery. Therefore, the driver can grasp vehicle information or the like with less eye movement than when looking at the meter in the instrument panel 9, improving convenience and safety.

The head-up display HUD includes the display device 1 and a hologram HOE.

The display device 1 projects light pertaining to an image (display light) toward the hologram HOE on the windshield WS located in front of the driver. The hologram HOE on the windshield WS reflects light pertaining to the image into the driver's eyebox. In this case, the display image VI based on the light pertaining to the image is formed in front of the driver's field of view when viewed from the viewpoint pertaining to the eyebox.

The hologram HOE may be formed, for example, by a photopolymer. The hologram HOE types are reflective, phase change, and volumetric. The hologram HOE may be formed utilizing a hologram film several microns thick. Interference fringes are recorded in the hologram HOE, for example in the form of a change in refractive index. In other words, interference fringes are stored in the hologram HOE in layers as a refractive index distribution inside the material. In the present example, interference fringes pertaining to each of the RGB wavelengths are recorded in the hologram HOE, corresponding to the three colored laser beams. In this case, a stacked hologram HOE may be formed by creating a hologram layer for each interference fringe pertaining to each of the RGB wavelengths and stacking the hologram layers pertaining to each. Alternatively, a multiplexed hologram HOE may be achieved, in which RGB interference fringes are recorded on top of each other. Any laser interference exposure device may be used to record (expose) such interference fringes.

As illustrated in FIG. 2, the display device 1 is provided with a light source unit 2, a rotary diffusion unit 3, a lens group 4 into which a laser beam that has passed through the rotary diffusion unit 3 is input, a liquid crystal panel 6, and a control unit 7.

The light source unit 2 synthesizes a plurality of laser beams of different colors (red laser beam R, green laser beam G, and blue laser beam B) to output a white synthesized beam. The details of the configuration of the light source unit 2 will be described below.

The rotary diffusion unit 3 diffuses the laser beam emitted from the light source unit 2. The rotary diffusion unit 3 has a function to multiplex the laser beam and reduce speckle.

As illustrated in FIG. 2, for example, the rotary diffusion unit 3 is provided with a disk-shaped diffusion member 31, a rotary motor 32 that rotates the diffusion member 31 with the circular center of the diffusion member 31 as the rotation axis, and a movement motor 33 that moves the incident position of the laser beam on the diffusion member 31 in the radial direction of the diffusion member 31 by moving the diffusion member 31 and the rotary motor 32 in the direction orthogonal to the optical path of the laser beam.

The diffusion member 31 is provided with an uneven pattern including a large number of unevenness on at least one surface. This uneven pattern is formed in such a manner that the circumferential unevenness pitch is larger on the inner circumference side (small rotation radius side) and smaller on the outer circumference side (large rotation radius side). The diffusion member 31 diffuses the incident laser beam even when the rotation is stopped, but when rotated by the rotary motor 32, the diffusion member 31 multiplexes the laser beam and provides speckle reduction effect. Further, increasing the number of rotations of the diffusion member 31 increases the number of times (per unit time) that the laser beam crosses the unevenness in the circumferential direction, thereby increasing the number of multiplexing and enhancing the speckle reduction effect.

Further, if the position of the laser beam incident on the rotating diffusion member 31 is moved to the outer circumference side of the diffusion member 31, the circumferential distance of the laser beam incident position increases, and the number of times the laser beam crosses the unevenness during one rotation of the diffusion member 31 increases, thereby increasing the number of multiplexing and further improving the speckle reduction effect. Further, if the position of the laser beam incident on the rotating diffusion member 31 is moved to the outer circumference side of the diffusion member 31, the uneven pitch of the laser beam incident position becomes smaller, and the number of times the laser beam crosses the unevenness during one rotation of the diffusion member 31 increases, thereby increasing the number of multiplexing and further improving the speckle reduction effect.

The lens group 4 has a collimator lens (a collimator unit) 41, a fly-eye lens 42, a condenser lens 43, a field lens 44, a lenticular lens 45, and a screen diffusion plate 46.

The collimator lens 41 receives the laser beam (diffused light) from the rotary diffusion unit 3. The collimator lens 41 has a function to uniformize the diffused light emitted from the rotary diffusion unit 3 while making collimating same.

The fly-eye lens 42 receives the laser beam (collimated beam) from the collimator lens 41. The fly-eye lens 42, for example, has a function to illuminate the screen of the liquid crystal panel 6 uniformly and in accordance with the screen shape (e.g., rectangular), regardless of the distribution of the incident light from the collimator lens 41.

The condenser lens 43, for example, has a function to superimpose the light emitted from the multiple sections of the fly-eye lens 42 on the screen of the liquid crystal panel 6. The condenser lens 43 may be configured to work in cooperation with fly-eye lens 42 to uniformize the distribution of light incident on the screen of liquid crystal panel 6.

The field lens 44, for example, has a function to superimpose the light emitted from the screen of the liquid crystal panel 6 on an eyebox (EyeBox).

The lenticular lens 45 has a function to adjust the diffusion angle, for example, when the diffusion angle of light generated by the fly-eye lens 42 is insufficient. The lenticular lens 45 may be configured to work in cooperation with the collimator lens 41 described above to widen the range of the eyebox and uniformize the luminance distribution (increase the degree of uniformity) in the eyebox. The lenticular lens 45 may be provided between the field lens 44 and the screen diffusion plate 46.

The screen diffusion plate 46, for example, functions to reduce luminance irregularity that may be caused by the liquid crystal panel 6 and lenticular lens 45.

The configuration of the lens group 4 is not limited to that illustrated in FIG. 2. For example, in a variation, the lenticular lens 45 may be omitted or other optics may be added.

The liquid crystal panel 6 forms the image for the display image VI with the use of the laser beam that has passed through the lens group 4 as a backlight. The display light emitted from the liquid crystal panel 6 is projected onto the hologram HOE as described above. Other optical systems (not illustrated) may be disposed between the liquid crystal panel 6 and the hologram HOE.

The control unit 7 includes, for example, a microcomputer and controls the light source unit 2, the rotary diffusion unit 3, and the liquid crystal panel 6. The details of the configuration of the control unit 7 will be described below.

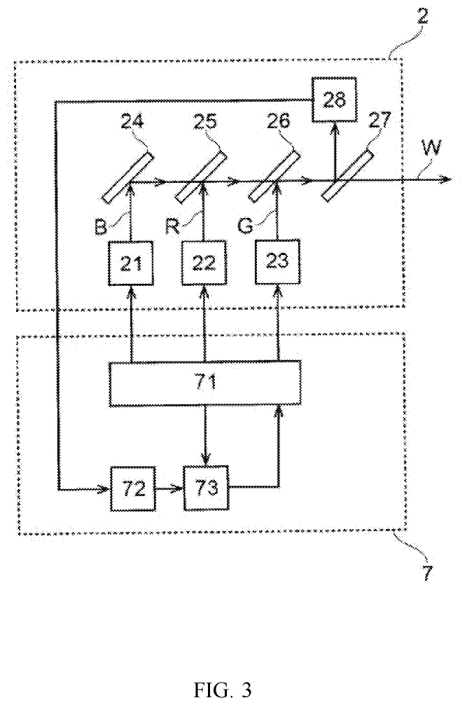

FIG. 3 is a block diagram illustrating configurations of laser light sources 21-23 and the control unit 7 according to a first embodiment.

As illustrated in FIG. 3, the light source unit 2 is provided with a plurality of laser light sources 21-23 that emit laser beams of different colors, synthesis units 24-26 that synthesize the plurality of laser beams, and an optical detection unit 28 that receives the laser beams that have passed through the synthesis units 24-26 via a low reflection transmission film 27 and detects the light intensity of the incident laser beams.

The plurality of laser light sources 21-23 include a blue laser light source 21 that emits a blue laser beam B, a red laser light source 22 that emits a red laser beam R, and a green laser light source 23 that emits a green laser beam G.

The synthesis units 24-26 include a first synthesis unit 24, a second synthesis unit 25, and a third synthesis unit 26. The first synthesis unit 24 is a dichroic mirror (blue reflection) that reflects the blue laser beam B toward the synthesis optical path. The second synthesis unit 25 is a dichroic mirror (red reflection, blue transmission) which is disposed in the laser emission direction of the red laser light source 22 and on the synthesis optical path and which reflects the red laser beam R toward the synthesis optical path while transmitting the blue laser beam B. The third synthesis unit 26 is a dichroic mirror (green reflection, blue red transmission) which is disposed in the laser emission direction of the green laser light source 23 and on the synthesis optical path and which reflects the green laser beam G toward the synthesis optical path while transmitting the blue laser beam B and the red laser beam R. The laser beams B, R, and G of each color that have passed through the synthesis units 24-26 are synthesized on the synthesis optical path to form a white laser beam W, which is emitted from the light source unit 2.

The low reflection transmission film 27 has a reflectance of approximately 5% and reflects a portion of the laser beams that have passed through the synthesis units 24-26 and inputs same to the optical detection unit 28. The optical detection unit 28 is configured with, for example, a light receiving element whose detection value (current value) fluctuates in accordance with the intensity of the laser beams.

As illustrated in FIG. 3, the control unit 7 is a control circuit board that controls the display device 1 and is provided with a microcontroller 71, a current/voltage conversion circuit 72 that converts the detected position of the optical detection unit 28 into a voltage value, and an amplifier circuit 73 that amplifies the output of the current/voltage conversion circuit 72. The gain of the amplifier circuit 73 is switched by the microcontroller 71.

The control unit 7 performs periodic switching between an all lighting mode and a single-color lighting mode. In the all lighting mode, all of the plurality of laser light sources 21-23 are turned on to emit a white laser beam W from the light source unit 2. In the single-color lighting mode, any one of the plurality of laser light sources 21-23 is turned on. Further, the control unit 7 detects the light intensity in the single-color lighting mode by the optical detection unit 28 and adjusts the gain of each laser light source 21-23 in the all lighting mode on the basis of the detection value of the optical detection unit 28.

According to such control unit 7, the liquid crystal panel 6 can be illuminated by synthesizing a plurality of laser beams B, R, G of different colors and the balance of the white laser beam W which is a synthesized beam can be adjusted with high accuracy. Further, by sequentially interrupting the single-color lighting mode of each color between the all lighting modes, as in “all lighting mode (W)”->“blue single-color lighting mode (B)”->“all lighting mode (W)”->“red single-color lighting mode (R)”->“all lighting mode (W)”->“green single-color lighting mode (G)”->“all lighting mode (W)” . . . , the ratio of single-color lighting modes in the lighting period can be reduced as much as possible. This prevents a user from visually recognizing single-color lighting or significant reduction in luminance due to single-color lighting. Furthermore, the light intensity of each color laser beam is detected by one optical detection unit 28, and thus the number of parts can be reduced compared to the case where the light intensity of each color laser beam is detected by individual optical detection units.

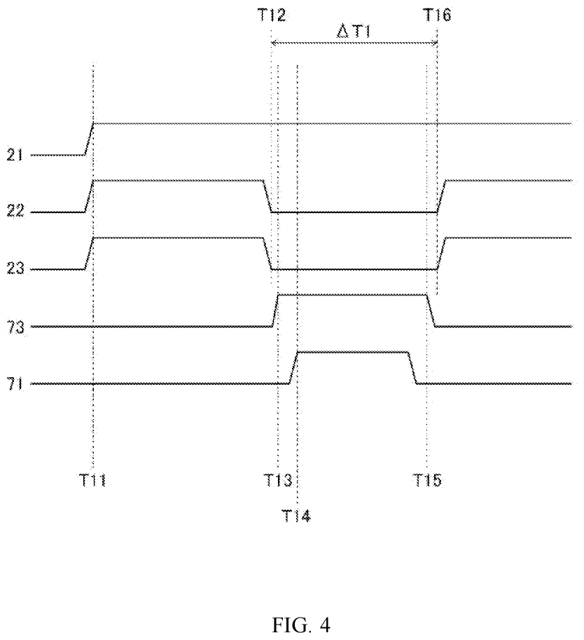

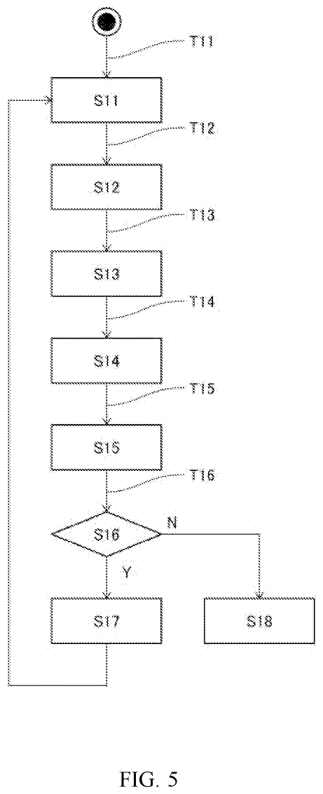

FIG. 4 is a timing chart illustrating an operating timing of the display device 1 according to the first embodiment, and FIG. 5 is a flowchart illustrating a control procedure of the display device 1 according the first embodiment.

As illustrated in FIGS. 4 and 5, when a predetermined timing (T11) is reached, the control unit 7 turns on all laser light sources 21-23 for a predetermined time (=T12−T11) and outputs the white laser beam W, which is the synthesized beam, from the light source unit 2 (step S11: all lighting mode).

When a predetermined timing (T12) is reached, the control unit 7 turns on only one color laser light source 21-23 (e.g., blue laser light source 21) out of the laser light sources 21-23 for a predetermined time (ΔT1=T16−T12) and outputs one color laser beam (e.g., blue laser beam B) from the light source unit 2 (step S12: single-color lighting mode).

After starting the single-color lighting mode (T13), the control unit 7 switches the gain of the amplifier circuit 73 from 0 to a predetermined value (a fixed value set for each color) in such a manner that the optical detection unit 28 can correctly acquire the light intensity of the single-color laser beam that is turned on in the single-color lighting mode (step S13).

After setting the gain of the amplifier circuit 73 (T14), the control unit 7 samples the detection value of the optical detection unit 28 multiple times at predetermined time intervals (step S14).

After multiple sampling is completed (T15), the control unit 7 sets the gain of the amplifier circuit 73 to 0 (step S15), and then determines whether the sampled light intensity in the single-color lighting mode is in a normal range (step S16).

If the determination result of step S16 is YES (normality determination), the control unit 7 adjusts the white balance of the white laser beam W in the all lighting mode by adjusting the applied voltage of each laser light source 21-23 on the basis of the sampled light intensity in the single-color lighting mode (step S17), and returns to step S11. By performing such a loop control of steps S11-S17 while switching the laser light sources 21-23 to be turned on monochromatically in step S12 in a predetermined order (B->R->G), the light intensity of the laser light sources 21-23 of all colors is fed back, enabling highly accurate white balance adjustment to be performed.

If the determination result of step S16 is NO (abnormality determination), the control unit 7 turns off the corresponding laser light sources 21-23 and displays an indication of abnormality on the liquid crystal panel 6 (step S18).

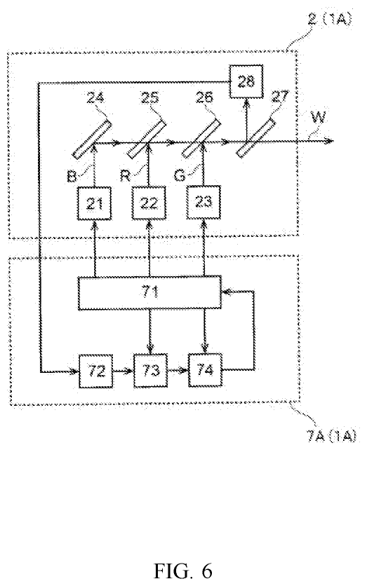

Next, a second embodiment of a display device 1A will be described with reference to FIGS. 6, 7, and 8. However, for configurations in common with the above-described embodiment, the description of the above-described embodiment may be referred to by using the same symbols as those of the above-described embodiment.

The display device 1A of the second embodiment differs from the display device 1 of the first embodiment described above in that the control unit 7 is replaced by a control unit 7A.

FIG. 6 is a block diagram illustrating configurations of laser light sources 21-23 and the control unit 7A according to the second embodiment.

The control unit 7A according to the second embodiment differs from the control unit 7 according to the first embodiment described above in that the control unit 7A has an additional holding circuit 74.

Specifically, the control unit 7A is provided with the microcontroller 71, the current/voltage conversion circuit 72, and the amplifier circuit 73, as well as the holding circuit 74. The holding circuit 74 has a function to hold the output of the amplifier circuit 73 and may have any configuration of various peak hold circuits. The gain of the amplifier circuit 73 is switched by the microcontroller 71. The voltage value held by the holding circuit 74 is acquired or reset by the microcontroller 71 at any given timing.

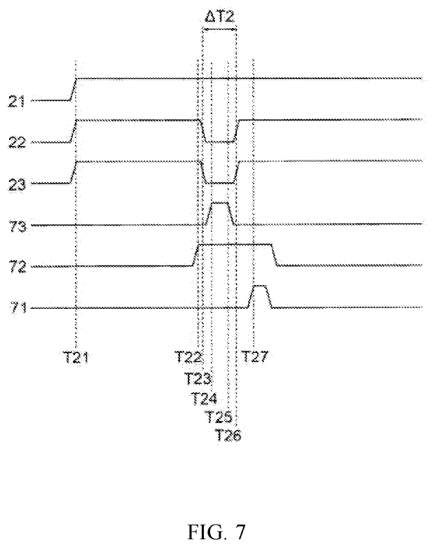

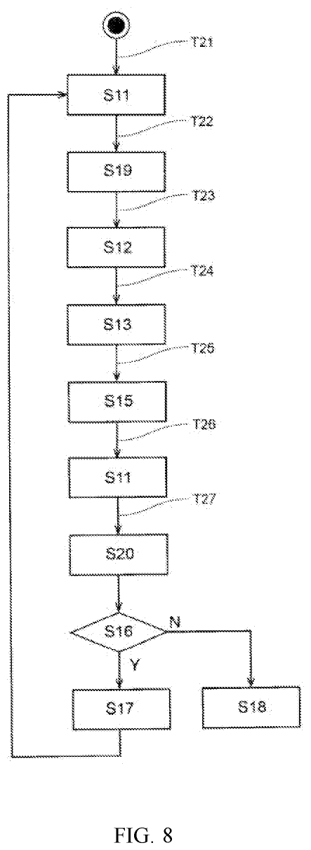

FIG. 7 is a timing chart illustrating an operating timing of the display device 1A according to the second embodiment, and FIG. 8 is a flowchart illustrating a control procedure of the display device 1A according the second embodiment.

The display device 1A of the second embodiment differs from the first embodiment described above in that the control unit 7A causes the detection value of the optical detection unit 28 to be held in the holding circuit 74 in the single-color lighting mode, captures the detection value held by the holding circuit 74 after switching to the all lighting mode, and adjusts the gain of each laser light source 21-23 in the all lighting mode on the basis of this detection value. According to such display device 1A of the second embodiment, the time in the single-color lighting mode (ΔT2<ΔT1) can be reduced compared to the aforementioned first embodiment, thus reducing the possibility that the user will visually recognize single-color lighting or that the luminance will be significantly reduced by single-color lighting.

Specifically describing the operation and control procedure of the second embodiment, when a predetermined timing (T21) is reached, the control unit 7A turns on all laser light sources 21-23 for a predetermined time (=T23−T21), and outputs the white laser beam W, which is the synthesized beam, from the light source unit 2 (step S11: all lighting mode).

When the predetermined timing (T22) is reached, the control unit 7A turns on the holding circuit 74 (step S19).

When a predetermined timing (T23) is reached, the control unit 7A turns on only one color laser light source 21-23 (e.g., blue laser light source 21) out of the laser light sources 21-23 for a predetermined time (ΔT2=T26−T23) and outputs one color laser beam (e.g., blue laser beam B) from the light source unit 2 (step S12: single-color lighting mode).

After starting the single-color lighting mode (T24), the control unit 7A switches the gain of the amplifier circuit 73 from 0 to a predetermined value (a fixed value set for each color) in such a manner that the optical detection unit 28 can correctly acquire the light intensity of the single-color laser beam that is turned on in the single-color lighting mode (step S13).

When a predetermined timing (T25) is reached, the control unit 7A sets the gain of the amplifier circuit 73 to 0 (step S15, T26), then turns on all laser light sources 21-23 for a predetermined time and outputs the white laser beam W, which is the synthesized beam, from the light source unit 2 (step S11: all lighting mode).

After starting the all lighting mode (T27), the control unit 7A acquires the light intensity during the single-color lighting mode held by the holding circuit 74 and turns off the holding circuit 74 after the acquisition (step S20).

The control unit 7A determines whether the light intensity in the single-color lighting mode acquired from the holding circuit 74 is in a normal range (step S16).

If the determination result of step S16 is YES (normality determination), the control unit 7A adjusts the white balance of the white laser beam W in the all lighting mode by adjusting the applied voltage of each laser light source 21-23 on the basis of the sampled light intensity in the single-color lighting mode (step S17), and returns to step S11. By performing such a loop control of steps S11-S17 while switching the laser light sources 21-23 to be turned on monochromatically in step S12 in a predetermined order (B->R->G), the light intensity of the laser light sources 21-23 of all colors is fed back, enabling highly accurate white balance adjustment to be performed.

If the determination result of step S16 is NO (abnormality determination), the control unit 7A turns off the corresponding laser light sources 21-23 and displays an indication of abnormality on the liquid crystal panel 6 (step S18).

Next, a variation applicable to the aforementioned first and second embodiments will be described.

This variation differs from the aforementioned embodiments in that a control unit (not illustrated) corresponding to the control unit 7 or the control unit 7A sets any one of the plurality of laser light sources 21-23 as a non-single-color lighting laser light source that is not turned on in the single-color lighting mode, and estimates the detection value of the non-single-color lighting laser light source on the basis of the detection value detected by the optical detection unit 28 during the single-color lighting mode and the detection value detected by the optical detection unit 28 during the all lighting mode. According to this variation, the number of times of the single-color lighting mode can be reduced compared to the aforementioned embodiments, thus reducing the possibility that the user will visually recognize single-color lighting or that the luminance will be significantly reduced by single-color lighting.

Specifically, if the circuit gain of the white laser beam W is a, the measured value is X, and the output is X/a; the circuit gain of the green laser beam G is b, the measured value is Y, and the output is Y/b; the circuit gain of the blue laser beam B is c, the measured value is Z, and the output is Z/c, the output of the red laser beam R can be calculated using the following formula (1).

R=(X/a)−(Y/b)−(Z/c) . . . (1) For example, if the circuit gain of the white laser beam W is 1, the measured value is 10, and the output is 10; the circuit gain of the green laser beam G is 2, the measured value is 5, and the output is 2.5; the circuit gain of the blue laser beam B is 4, the measured value is 5, and the output is 1.25, the output (calculated value) of the red laser beam R in the above formula (1) is 6.25.

Here, from the perspective of visual sensitivity, the non-single-color lighting laser light source is preferably the blue laser light source 21 or the red laser light source 22 for wavelengths with relatively low visual sensitivity, and from the perspective of detection accuracy, the red laser light source 22 with relatively high output is preferable. However, the non-single-color lighting laser light source may be not fixed, and may be appropriately changed so as to be changed in accordance with a predetermined order from three or two of the blue laser light source 21, red laser light source 22, and green laser light source 23.

Although the embodiments have been described in detail above, the present disclosure is not limited to a specific embodiment, and various modifications and changes may be made within the scope of the claims. Furthermore, all or some of the components in the embodiments described above may be combined.

For example, in the aforementioned embodiments, three color laser beams R, G, and B are synthesized to obtain a white laser beam W. In principle, however, the white laser beam W may be obtained by synthesizing laser beams of two colors in a complementary color relation.

### DESCRIPTION OF REFERENCE NUMERALS

1 display device
2 light source unit
21 blue laser light source
22 red laser light source
23 green laser light source
24 first synthesis unit
25 second synthesis unit
26 third synthesis unit
27 low reflection transmission film
28 optical detection unit
3 rotary diffusion unit
31 diffusion member
32 rotary motor
33 movement motor
4 lens group
41 collimator lens
42 fly-eye lens
43 condenser lens
44 field lens
45 lenticular lens
46 screen diffusion plate
6 liquid crystal panel
7 control unit
71 microcontroller
72 current/voltage conversion circuit
73 amplifier circuit
74 holding circuit
9 instrument panel
VC vehicle
VI display image (virtual image display)
WS windshield

1. A display device comprising
a plurality of laser light sources that emit a plurality of laser beams of different colors;
synthesis units that synthesize the plurality of laser beams and emit a synthesized beam;
a collimator unit that collimates the synthesized beam and emits a collimated beam;
a liquid crystal panel that forms an image for display; and
a control unit that controls the plurality of laser light sources, the display device illuminating the liquid crystal panel with the collimated beam and further comprising an optical detection unit that detects light intensity of the laser beams that have passed through the synthesis units,
wherein the control unit performs periodic switching between an all lighting mode in which all of the plurality of laser light sources are turned on and a single-color lighting mode in which any one of the plurality of laser light sources is turned on, detects the light intensity in the single-color lighting mode by the optical detection unit, and adjusts a gain of each laser light source in the all lighting mode on basis of a detection value detected by the optical detection unit.

2. The display device according to claim 1, further comprising a holding circuit that holds the detection value detected by the optical detection unit,
the control unit causes the holding circuit to hold the detection value during the single-color lighting mode, captures the detection value held by the holding circuit after switching to the all lighting mode, and adjusts the gain of each laser light source in the all lighting mode on basis of the detection value.

3. The display device according to claim 1, wherein the control unit sets any one of the plurality of laser light sources as a non-single-color lighting laser light source that is not turned on in the single-color lighting mode, and estimates the light intensity pertaining to the non-single-color lighting laser light source on basis of the detection value detected by the optical detection unit during the single-color lighting mode and the detection value detected by the optical detection unit during the all lighting mode.
